(19) United States
(12) Patent Application Publication
(10) Pub. No.: US 2019/0391849 A1
(43) Pub. Date: Dec. 26, 2019

(54) Method for Processing Service

(71) Applicant: TMAXSOFT CO., LTD., Seongnam-si (KR)

(72) Inventors: Junsoo Jeong, Seongnam-si (KR); Moon Namkoong, Seongnam-si (KR)

(21) Appl. No.: 16/018,780

(22) Filed: Jun. 26, 2018

(30) Foreign Application Priority Data
Jun. 22, 2018 (KR) 10-2018-0072269

(51) Int. Cl. G06F 9/50; G06F 9/54; G06F 9/48

(52) U.S. Cl. CPC G06F 9/5038; G06F 9/4806; G06F 9/54

(57) ABSTRACT

According to one exemplary embodiment of the present disclosure, a computer program stored in a computer readable storage medium is disclosed. The computer program may make operations for processing a service to be performed when the computer program is executed in one or more processors of a computing device, and the operations may include: an operation of allocating, by a control thread, processing of a first service to one worker thread among worker threads; an operation of performing, by the worker thread, the processing of the first service and determining whether a call of a second service is required for processing the first service; an operation of transferring, by the worker thread, service call information to an interworking support unit when the worker thread determines that the call of the second service is required for processing the first service; an operation of receiving, by the interworking support unit, a processing result of the second service; and an operation of transferring, by the interworking support unit, the processing result of the second service to the worker thread or another worker thread so that the processing of the first service is resumed.

### CROSS-REFERENCE TO RELATED APPLICATIONS

This application claims priority to and the benefit of Korean Patent Application No. 10-2018-0072269 filed in the Korean Intellectual Property Office on Jun. 22, 2018, the entire contents of which are incorporated herein by reference.

### TECHNICAL FIELD

The present disclosure relates to a method of processing a service, and more particularly, to interworking and processing services.

### BACKGROUND ART

In a generally used service-based application, all requests are treated as services. Accordingly, when another server or a server itself requires a specific operation, a request for an operation with respect to the requirement may also be a service. Accordingly, a framework for the application provides a separate service interworking API for supporting calling or interworking of these services to provide an interworking function for calling specific performance logic within another server or the same server. However, in the interworking scheme, the specific service needs to separately call another service within another server or the same server, but when the service to be called does not support the calling, there may be a problem in processing the service. For example, it is assumed that server A needs to call a service from server B, but instead of directly refusing to receive a call for security reasons, server B operates in a scheme, in which server B pushes a service result required by server A whenever the processing of the service is performed. In this case, server A cannot directly call the service from server B, so that server A needs to periodically inquire a result until server B records the service result in a common database, causing a problem in that the processing is delayed.

Korean Patent No. KR1638136 discloses a method of minimizing lock competition between threads during a distribution of tasks in a multi-thread structure.

### SUMMARY OF THE INVENTION

The present disclosure is conceived in response to the foregoing background technology, and provides a method of controlling a service.

According to an exemplary embodiment of the present disclosure for achieving the object, a computer program stored in a computer readable storage medium is disclosed. The computer program may make operations for processing a service to be performed when the computer program is executed in one or more processors of a computing device, and the operations may include: an operation of allocating, by a control thread, processing of a first service to one worker thread among worker threads; an operation of performing, by the worker thread, the processing of the first service and determining whether a call of a second service is required for processing the first service; an operation of transferring, by the worker thread, service call information to an interworking support unit when the worker thread determines that the call of the second service is required for processing the first service; an operation of receiving, by the interworking support unit, a processing result of the second service; and an operation of transferring, by the interworking support unit, the processing result of the second service to the worker thread or another worker thread so that the processing of the first service is resumed.

In an alternative exemplary embodiment of the present disclosure, the operation of transferring, by the worker thread, the service call information to the interworking support unit when the worker thread determines that the call of the second service is required for processing the first service may include an operation of storing, by the worker thread, a processing state of the first service and stopping the processing of the first service.

In the alternative exemplary embodiment of the present disclosure, the service call information may include at least one of identification information about a service calling a service, identification information about a service desired to be called, and transaction identification information.

In the alternative exemplary embodiment of the present disclosure, the computer program may further include after the operation of transferring, by the worker thread, the service call information to the interworking support unit when the worker thread determines that the call of the second service is required for processing the first service, an operation of allocating, by the control thread, processing of another service, which is different from the first service and the second service, to the worker thread.

In the alternative exemplary embodiment of the present disclosure, the second service may be the service different from the first service, and may be the service, which needs to be processed first, for completion of the processing of the first service.

In the alternative exemplary embodiment of the present disclosure, the computer program may further include an operation of interworking, by the interworking support unit, the received processing result of the second service with the first service based on the service call information.

In the alternative exemplary embodiment of the present disclosure, the processing result of the second service may include at least one of processing result information about the second service, identification information about the first service, and transaction identification information.

In another exemplary embodiment of the present disclosure, a method of processing a service performed by one or more processors of a computing device is disclosed. The method may include: allocating, by a control thread, processing of a first service to one worker thread among worker threads; performing, by the worker thread, the processing of the first service and determining whether a call of a second service is required for processing the first service; transferring, by the worker thread, service call information to an interworking support unit when the worker thread determines that the call of the second service is required for processing the first service; receiving, by the interworking support unit, a processing result of the second service; and transferring, by the interworking support unit, the processing result of the second service to the worker thread or another worker thread so that the processing of the first service is resumed.

In still another exemplary embodiment of the present disclosure, a computing device for processing a service is disclosed. The computing device may include: a processor including one or more cores; and a memory configured to store commands performable by the processor, in which in the processor, a control thread may allocate processing of a first service to one worker thread among worker threads; the worker thread may perform the processing of the first service and determine whether a call of a second service is required for processing the first service; the worker thread may transfer service call information to an interworking support unit when the worker thread determines that the call of the second service is required for processing the first service; the interworking support unit may receive a processing result of the second service; and the interworking support unit may transfer the processing result of the second service to the worker thread or another worker thread so that the processing of the first service is resumed.

The present disclosure may provide a service control method.

### BRIEF DESCRIPTION OF THE DRAWINGS

FIG. 1 is a block diagram of a computing device performing a method of processing a service according to an exemplary embodiment of the present disclosure.

FIG. 2 is a schematic diagram illustrating interworking processing of a service according to an exemplary embodiment of the present disclosure.

FIG. 3 is a flowchart of a service processing method according to an exemplary embodiment of the present disclosure.

FIG. 4 is a block diagram illustrating means for implementing the service processing method according to the exemplary embodiment of the present disclosure.

FIG. 5 is a block diagram illustrating modules for implementing the service processing method according to the exemplary embodiment of the present disclosure.

FIG. 6 is a block diagram illustrating circuits for implementing the service processing method according to the exemplary embodiment of the present disclosure.

FIG. 7 is a block diagram illustrating logic for implementing the service processing method according to the exemplary embodiment of the present disclosure.

FIG. 8 is a simple and general schematic diagram of an illustrative computing environment, in which the exemplary embodiments of the present disclosure may be implemented.

### DETAILED DESCRIPTION

Hereinafter, various exemplary embodiments are described with reference to the drawings. In the present specification, various descriptions are presented for understanding the present disclosure. However, it is apparent that the exemplary embodiments may be carried out even without the particular description.

Terms, “component”, “module”, “system”, and the like used in the present specification indicate a computer-related entity, hardware, firmware, software, a combination of software and hardware, or execution of software. For example, a component may be a procedure executed in a processor, a processor, an object, an execution thread, a program, and/or a computer, but is not limited thereto. For example, both an application executed in a computing device and the computing device may be components. One or more components may reside within a processor and/or an execution thread. One component may be localized within one computer. One component may be distributed between two or more computers. Further, the components may be executed by various computer readable medium having various data structures stored therein. For example, components may communicate through local and/or remote processing according to a signal (for example, data transmitted to another system through a network, such as Internet, through data and/or a signal from one component interacting with another component in a local system and a distributed system) having one or more data packets.

A term “or” intends to mean comprehensive “or”, not exclusive “or”. That is, unless otherwise specified or when it is unclear in context, “X uses A or B” is intended to mean one of the natural comprehensive substitutions. That is, when X uses A, X uses B, or X uses both A and B, “X uses A or B” may be applied to any one among the cases. Further, a term “and/or” used in the present specification shall be understood to designate and include all of the possible combinations of one or more items among the listed relevant items.

A term “include” and/or “including” shall be understood as meaning that a corresponding characteristic and/or a constituent element exists. However, it shall be understood that the term “include” and/or “including” does not exclude the existence or an addition of one or more other characteristics, constituent elements, and/or a group thereof. Further, unless otherwise specified or when it is unclear that a singular form is indicated in context, the singular form shall be construed to generally mean “one or more” in the present specification and the claims.

Those skilled in the art shall recognize that the various illustrative logical blocks, configurations, modules, circuits, means, logic, and algorithm operations described in relation to the exemplary embodiments additionally disclosed herein may be implemented by electronic hardware, computer software, or in a combination of electronic hardware and computer software. In order to clearly exemplify interchangeability of hardware and software, the various illustrative components, blocks, configurations, means, logic, modules, circuits, and operations have been generally described above in the functional aspects thereof. Whether the functionality is implemented by hardware or software depends on a specific application or design restraints given to the general system. Those skilled in the art may implement the functionality described by various methods for each of the specific applications. However, it shall not be construed that the determinations of the implementation deviate from the range of the contents of the present disclosure.

The descriptions of the presented exemplary embodiments are provided so as for those skilled in the art to use or carry out the present invention. Various modifications of the exemplary embodiments will be apparent to those skilled in the art. General principles defined herein may be applied to other exemplary embodiments without departing from the scope of the present disclosure. Therefore, the present invention is not limited to the exemplary embodiments presented herein. The present invention shall be interpreted within the broadest meaning range consistent to the principles and new characteristics presented herein.

In the present specification, a service may be exchanged with a service request and used. A service according to the present disclosure is defined by a combination of micro services configured according to a flow of data. Processing of a service may also be performed in a control thread according to the kind of service. Processing of a service may be performed in a worker thread according to the kind of service. How to group transactions according to a database task performed in a micro service may be determined while an entire service is performed. How to apply a transaction according to a database task performed in a micro service may be determined while an entire service is performed.

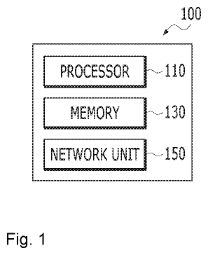

FIG. 1 is a block diagram of a computing device performing a method of processing a service according to an exemplary embodiment of the present disclosure. A configuration of a computing device 100 illustrated in FIG. 1 is simply a simplified illustrated example. In the exemplary embodiment of the present disclosure, the computing device 100 may include other configurations for performing a computing environment of the computing device 100, and only a part of the disclosed configurations may also configure the computing device 100.

The computing device 100 may include a processor 110, a memory 130, and a network unit 150.

The processor 110 may be formed of one or more cores, and may include a processor for processing data, such as a central processing unit (CPU), a general purpose graphics processing unit (GPGPU), and a tensor processing unit (TPU) of the computing device. The processor 110 may read a computer program stored in the memory 130 and perform a service processing method according to an exemplary embodiment of the present disclosure.

The processor 110 may allocate processing of a service to a worker thread. The processor 110 may include a worker thread and a control thread. The worker thread may perform processing of a service. The control thread may allocate processing of a service to the worker thread. In the disclosure, a service may indicate a set of a series of operations performed in a computer. For example, a service may include a series of operations of a computer device for buying vitamins in an online shopping mall by a user. For example, a service may include an operation of receiving an order of a user, an operation of receiving settlement information of the user, an operation of transferring the settlement information of the user to a settlement agency and performing a settlement for a product, an operation of receiving delivery information from the user, and the like. The control thread of the processor 110 may allocate processing of a first service to one worker thread among the worker threads. The first service may include a set of a series of operations performed in a computer as described above. The detailed description of the service is illustrative, and a service of the present disclosure may include a set of predetermined operations for processing a predetermined process in a computing device.

The worker thread of the processor 110 may process the service, and detect whether a call of another service is required for processing of the service. For example, in the example for the service for buying the vitamins in the online shopping mall, when the user selects a deposit without a bankbook, checking whether the user makes a deposit for settlement cost to an account of a seller may be another service, and it may be required to check a processing result of another service for progressing the service (that is, vitamin buying and dispatching procedures). The processor 110 may process the first service, and determine whether a call of a second service is required for processing the first service. When a result value of another service is required for processing the first service, the processor 110 may determine that the call of another service is required for processing the first service. Further, when the processing of another service needs to be preceded for processing the first service, the processor 110 may determine that the call of another service is required for processing the first service. For example, when a specific input is required for processing the first service, the processor 110 may determine that the call of another service is required. In the example of buying the vitamins, the computing device performing the first service may not make a request for processing of the checking whether the user makes the deposit for the settlement cost to the account of the seller for security reasons. Further, when the user does not make the deposit for the settlement cost to the account of the seller, the progress of the service related to the buying of the vitamins may be temporarily stopped (that is, when the user does not settle product cost, it is impossible to instruct the dispatch of the product to the seller). In this case, the worker thread processing the service related to the buying of the vitamins may temporarily stop the service related to the buying of the vitamins, and may be allocated with the processing of another service and process another service. That is, when it is impossible to compel the processing of the second service, which is different from the first service and needs to precede the processing of the first service, in the computing device 100 processing the first service, the processing of the first service may be temporarily stopped, and may be resumed when a processing result of the second service is received. In the foregoing example, in the progress of the first service related to the buying of the vitamins, when the buyer does not make the deposit to the account of the seller, a processing operation may not be progressed. In this case, in the first service, the deposit of the buyer cannot be called, but a result of the deposit of the buyer may be received and processed. Accordingly, the processor 110 processing the first service may temporarily stop the progress of the first service in this case, and stand-by for a result of the processing of the second service (the deposit result of the buyer in the foregoing example). The description of the service is simply illustrative, and the present disclosure is not limited thereto.

When it is determined that the call of another service is required for processing the service, the processor 110 may transfer service call information to an interworking support unit 230. In this case, the worker thread of the processor 110 may store a processing state of the service and stop the processing of the service. The interworking support unit 230 may perform a series of operations for interworking a service, of which a call from another service is not supported, with another service. The interworking support unit 230 may also be a thread in the computing device 100, and may also be a separate device independent from the computing device 100. The service call information may include information required for the interworking between the services, and may include identification information about a service (that is, a host service) calling a service, and identification information and transaction identification information about a service (that is, a participating service) desired to be called. The identification information about the service may include a name of the service. The transaction identification information is information, based on which it is possible to determine that a host service and a participating service belong to one transaction, and for example, a unique value in a transaction. For example, identification information about a service calling a service may be a buying service in the foregoing example. The identification information about the service desired to be called may be, for example, a service for checking the deposit without requiring the bankbook. The transaction information may, for example, include information for determining that the service for buying the vitamins and the service for checking the deposit without requiring the bankbook are the services included in the same transaction. That is, a plurality of kinds of the service may be processed in the computing device 100, and even though the service have the same name, the service may be included in a different transaction (for example, a case where a buyer is different in the same vitamin buying service, and a case where vitamins are bought at a different time from that of the previous buying). In the case of the services which need to be interworked with each other, one piece of transaction identification information may be allocated. In the foregoing example, the same transaction identification information may be allocated to the vitamin buying service and the service for checking the deposit without requiring the bankbook from the buyer.

When the worker thread of the processor 110 determines that the call of another service is required for processing the service, the worker thread of the computing device 100 may transfer service call information to the interworking support unit 230 and then the control thread may also allocate the processing of another service to the worker thread. The interworking support unit 230 may have the service call information. More particularly, the interworking support unit 230 may store the service call information in at least one of a main memory and a permanent storage device. That is, when the call of another service is required for processing the service, the worker thread of the processor 110 may be impossible to process the service until a result value of another service arrives. In this case, the worker thread of the processor 110 does not wait for the result value of another service, but may stop the processing of the service, be allocated with another service, and process the allocated service. The worker thread does not wait in the situation where the processing of the service cannot be progressed any longer, but is allocated with another service and processes the allocated service, thereby improving availability of the system, and decreasing an idle resource of the computing device 100 and improving performance of processing the service. When the worker thread of the processor 110 determines that a call of the second service is required for processing the first service, the worker thread of the processor 110 transfers service call information to the interworking support unit 230, and the control thread may allocate the processing of another service, which is different from the first service and the second service, to the worker thread. In the example of the vitamin buying service, the worker thread cannot progress the processing of the vitamin buying service until the result of the deposit without requiring the bankbook from the user is received, and in this case, the worker thread may be allocated with another service (for example, a service for buying a gift card from another user) and process the allocated service.

The interworking support unit 230 may receive a processing result of another service, and interwork the processing result of another service to a service (that is, a host service) requesting the interworking. The interworking support unit 230 may determine whether the received processing result of another service is a processing result for the service, which waits for interworking, based on the service call information. The interworking support unit 230 may receive a processing result of the second service, and may determine that the second service is the service, which the first service waits for interworking, based on at least one piece of processing result information about the processing result of the second service, and the identification information and the transaction identification information about the first service. More particularly, the interworking support unit 230 may read the transaction identification information from the processing result of the second service, and determine service call information including the corresponding transaction identification information. The interworking support unit 230 may determine the service, which is waiting for interworking, based on the determined service call information. For example, in the example related to buying the vitamin, when the interworking support unit 230 receives the processing result of the deposit without requiring the bankbook, the interworking support unit 230 may determine the service, which waits for the received result of the processing of the deposit without requiring the bankbook, based on the transaction identification information included in the processing result of the deposit without requiring the bankbook, identification information about a call service, and the like. In the foregoing example, the interworking support unit 230 may receive the processing result of the deposit without requiring the bankbook, and determine that the processing result of the deposit without requiring the bankbook is the result, which the vitamin buying service waits for as a response, based on at least one piece of the transaction identification information and the identification information about the call service. The interworking support unit 230 may determine the service, which is waiting for the processing result of another service, and when the interworking support unit 230 receives the processing result of another service, the waiting service may be resumed. The interworking support unit 230 may provide the control thread with a signal indicating that the processing result (that is, the performance result of the second service), which the waiting service (that is, the first service) waits, is received, and the control thread may allocate the waiting service to the worker thread. Further, the interworking support unit 230 may also provide the worker thread with a signal indicating that the processing result of the second service, which the first service waits, is received. In this case, the worker thread, to which the waiting service is re-allocated, may also be the same as or different from the worker thread which initially processes the service. The interworking support unit 230 may transfer the processing result (that is, the performance result of the second service) to the worker thread, which is processing the resumed service (that is, the first service), and enable the worker thread to process the service. The interworking support unit 230 may support the interworking between the services, which cannot be directly called. In the foregoing example, the second service cannot be directly called and processed by the worker thread processing the first service, so that the worker thread processing the first service needs to wait for the processing result of the second service. Further, the second service cannot be directly called, so that the kind of transaction, which the processing result of the second service needs to be interworked, may be managed by the interworking support unit 230. In the exemplary embodiment of the present disclosure, the interworking support unit supports the interworking between the services, which cannot be directly called, thereby enabling the host service (that is, the service requesting the interworking of the service) to be processed. In the exemplary embodiment of the present disclosure, the processing result of the participating service (that is, the service interworked with the host service) is transferred to the waiting host service, so that it is possible to support the interworking between the services, and the processing of the host service is prevented from being waited unlimitedly, so that it is possible to allow the thread processing the host service to process another task, thereby decreasing an idle resource of the computing device and improving performance of the computing device.

The network unit 150 may include a transmitting unit and a receiving unit. The network unit 150 may include a wire/wireless Internet module for a network connection. As the wireless Internet technology, a wireless local area network (WLAN, Wi-Fi), a wireless broadband (Wibro), world interoperability for microwave access (Wimax), and high speed downlink packet access (HSDPA), and the like may be used. As the wired Internet technology, a digital subscriber line (XDSL), fibers to the home (FTTH), power line communication (PLC), and the like may be used.

The network unit 150 may include a short range communication module, and may transceive data with an electronic device, which is relatively close to a service processing device and includes a short range communication module. As a short range communication technology, Bluetooth, radio frequency identification (RFID), infrared data association (IrDA), ultra-wideband (UWB), ZigBee, and the like may be used. In the exemplary embodiment of the present disclosure, the network unit 150 may detect a connection state of a network and a transception rate of a network. The data received through the network unit 150 may be stored through a memory, or may be transmitted to other electronic devices located within a short range through the short range communication module.

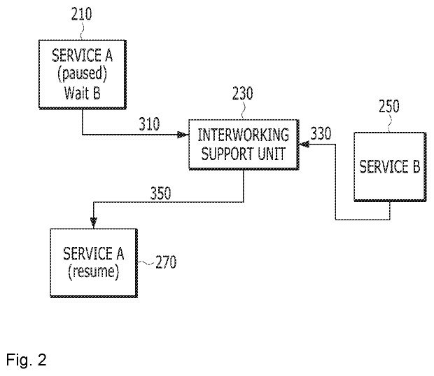

FIG. 2 is a schematic diagram illustrating interworking processing of a service according to an exemplary embodiment of the present disclosure.

The worker thread may process service A 210. When service A 210 is processed, interworking with service B 250 may be required. Service B 250 is a service, which needs to be preceded for processing service A 210, and may be a service, of which the processing cannot be compelled by service A 210. Service A 210 may be processed by the computing device, and the computing device 100 may process up to a part, which does not need to be interworked with service B 250, during the processing process of service A 210, and wait for a processing result of service B 250 from a process, which needs to be interworked with service B 250. In this case, the worker thread may transfer service call information indicating that service A 210 is waiting for the interworking with service B 250 to the interworking support unit 230 (310). When the interworking support unit 230 receives the service call information, the interworking support unit 230 may store the service call information. The interworking support unit 230 cannot directly call the processing of service B 250, but when service B 250 is processed by another worker thread or another computing device and a processing result is received (330), the interworking support unit 230 may determine the service, in relation to which the received processing result is the processing result of the interworking request. That is, the interworking support unit 230 may receive the processing result of another service (330), and determine the service (that is, service A in this case), which is waiting for the processing result of another service and requests interworking, based on transaction identification information included in the processing result of another service. The interworking support unit 230 may transfer the processing result of another service to the control thread or the worker thread (350), and enable the processing of the stopped service to be resumed. Resumed service A 270 may include a series of operations to be performed after the processing of service B 250.

For example, in the foregoing example, service A 210 may include a series of operations of the computing device related to the vitamin buying in the online shopping mall. When a buyer desires to buy vitamins by the scheme of a deposit without a bankbook, a delivery processing of a product may be initiated only when the buyer makes a deposit for a product cost amount to an account of the seller. In this case, the worker thread may perform operations before the deposit for the product cost amount in service A (for example, an operation of recording a delivery address input from the buyer and an operation of sending a guidance of a deposit without a bankbook to the buyer), and may stop the processing of service A until the buyers makes the deposit for the product cost amount. That is, in the foregoing example, before the buyer makes the deposit for the product cost amount, it is impossible to send a delivery request to the seller, so that the computing device or the thread processing service A temporarily stops the processing of service A. The computing device or the thread processing service A may transfer service call information for notifying that service A is waiting for the processing result of service B, to the interworking support unit 230. In the present example, the service call information may include identification information (that is, information about a name of a service, such as the vitamin buying service) for determining the host service, identification information (that is, information about a name of a service, such as checking deposit without bankbook) of the participant service desired to be called, and transaction identification information (information for dividing a set of a series of operations to be performed as a service and a set of other operations, for example, a user and a product to which a buying service is related). When the interworking support unit 230 receives the checking of the deposit without requiring the bankbook (that is, the processing result of service B), the interworking support unit 230 may determine the host service, for which the received checking of the deposit without requiring the bankbook is a performance result of the participant service, based on the transaction identification information. The interworking support unit 230 may determine the host service which waits for the processing result of the participant service, allow the processing of the host service to be resumed, transfer the processing result of the participant service to the resumed host service 270 (350), and allow the host service to be processed.

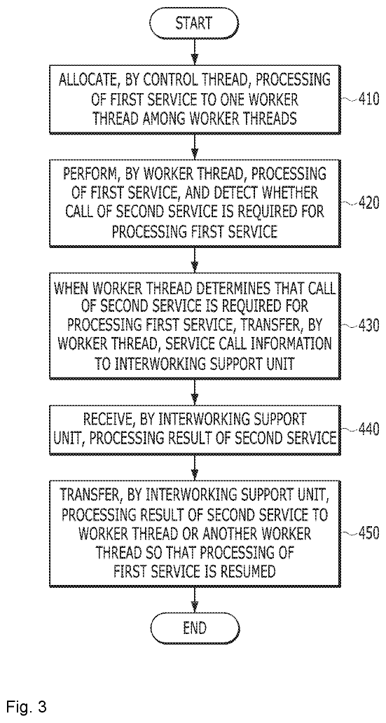

FIG. 3 is a flowchart of a method of processing a service according to an exemplary embodiment of the present disclosure.

The control thread of the computing device 100 may allocate processing of a first service to one worker thread among the worker threads (410). In the disclosure, a service may indicate a combination of the series of operations performed in a computer.

The worker thread of the computing device 100 may perform the processing of the first service, and may detect whether a call of a second service is required for processing the first service while performing the processing of the first service (420). For example, when the computing device 100 needs a specific input value (for example, a processing result value of the second service) for processing the first service, the computing device 100 may determine that a call of the second service is required for processing the first service.

When the worker thread of the computing device 100 determines that the call of the second service is required for processing the first service, the worker thread of the computing device 100 may transfer service call information to the interworking support unit 230 (430). The interworking support unit 230 may be the thread of the computing device 100, or may also be another computing device different from the computing device 100. The interworking support unit 230 may record the service call information. In this case, the computing device 100 may allocate another service to the worker thread and make the allocated service to be processed, thereby improving availability of the computing device 100.

The interworking support unit 230 may receive a processing result of the second service (440). The second service is a service, of which an external call is impossible, and the computing device 100 processing the first service cannot compel the processing of the second service. When the second service is performed, the interworking support unit may receive the processing result.

The interworking support unit 230 may determine the kind of first service, to which the processing result of the second service is related, and may transfer the processing result of the second service to the computing device processing the first service so that the processing of the first service is resumed. The processing result of the second service may include information for determining the first service, which is waiting for the processing result of the second service. For example, the interworking support unit 230 may determine the first service based on the transaction identification information of the processing result of the second service.

In the exemplary embodiment of the present disclosure, the interworking between the services, which cannot be directly called, is supported, thereby improving reliability of the computing device 100, and it is prevented from the processing of the service from being unlimitedly waited, thereby minimizing an idle resource of the computing device 100. According to the service processing method of the exemplary embodiment of the present disclosure, it is possible to improve availability of the computing device 100 and improve a processing speed of the service, thereby improving processing performance of the computing device 100.

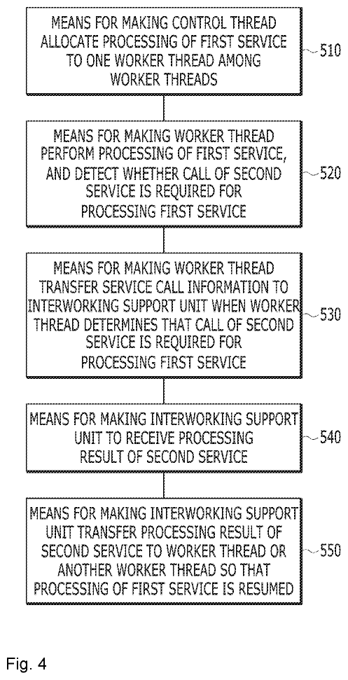

FIG. 4 is a block diagram illustrating means for implementing the service processing method according to the exemplary embodiment of the present disclosure.

The service processing method according to the exemplary embodiment of the present disclosure may be implemented by the means described below.

The service processing method according to the exemplary embodiment of the present disclosure may be implemented by: a means 510 for making the control thread allocate processing of a first service to one worker thread among the worker threads; a means 520 for making the worker thread perform the processing of the first service and making the worker thread determine whether a call of a second service is required for processing the first service; a means 530 for making the worker thread transfer service call information to the interworking support unit when the worker thread determines that the call of the second service is required for processing the first service; a means 540 for making the interworking support unit receive a processing result of the second service; and a means 550 for making the interworking support unit transfer the processing result of the second service to the worker thread or another worker thread so that the processing of the first service is resumed.

In an alternative exemplary embodiment of the service processing method, the service processing method may also include a means for making the worker thread store a processing state of the first service and making the worker thread stop the processing of the first service.

In the alternative exemplary embodiment of the service processing method, the service processing method may also further include a means for, when the worker thread determines that the call of the second service is required for processing the first service, making the control thread allocate processing of another service, which is different from the first service and the second service, to the worker thread after the operation of transferring the service call information to the interworking support unit.

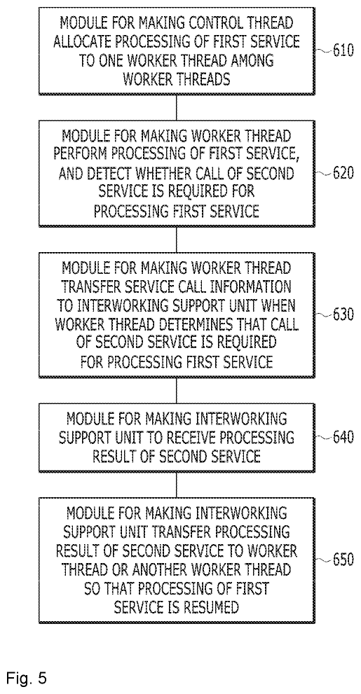

FIG. 5 is a block diagram illustrating modules for implementing the service processing method according to the exemplary embodiment of the present disclosure.

The service processing method according to the exemplary embodiment of the present disclosure may be implemented by the modules described below.

The service processing method according to the exemplary embodiment of the present disclosure may be implemented by: a module 610 for making the control thread allocate processing of a first service to one worker thread among the worker threads; a module 620 for making the worker thread perform the processing of the first service and making the worker thread determine whether a call of a second service is required for processing the first service; a module 630 for making the worker thread transfer service call information to the interworking support unit when the worker thread determines that the call of the second service is required for processing the first service; a module 640 for making the interworking support unit receive a processing result of the second service; and a module 650 for making the interworking support unit transfer the processing result of the second service to the worker thread or another worker thread so that the processing of the first service is resumed.

In an alternative exemplary embodiment of the service processing method, the service processing method may also include a module for making the worker thread store a processing state of the first service and making the worker thread stop the processing of the first service.

In the alternative exemplary embodiment of the service processing method, the service processing method may also further include a module for, when the worker thread determines that the call of the second service is required for processing the first service, making the control thread allocate processing of another service, which is different from the first service and the second service, to the worker thread after the operation of transferring the service call information to the interworking support unit.

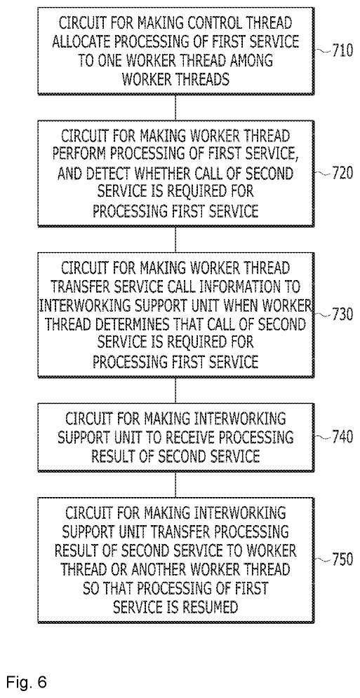

FIG. 6 is a block diagram illustrating circuits for implementing the service processing method according to the exemplary embodiment of the present disclosure.

The service processing method according to the exemplary embodiment of the present disclosure may be implemented by the circuits described below.

The service processing method according to the exemplary embodiment of the present disclosure may be implemented by: a circuit 710 for making the control thread allocate processing of a first service to one worker thread among the worker threads; a circuit 720 for making the worker thread perform the processing of the first service and making the worker thread determine whether a call of a second service is required for processing the first service; a circuit 730 for making the worker thread transfer service call information to the interworking support unit when the worker thread determines that the call of the second service is required for processing the first service; a circuit 740 for making the interworking support unit receive a processing result of the second service; and a circuit 750 for making the interworking support unit transfer the processing result of the second service to the worker thread or another worker thread so that the processing of the first service is resumed.

In an alternative exemplary embodiment of the service processing method, the service processing method may also include a circuit for making the worker thread store a processing state of the first service and making the worker thread stop the processing of the first service.

In the alternative exemplary embodiment of the service processing method, the service processing method may also further include a circuit for, when the worker thread determines that the call of the second service is required for processing the first service, making the control thread allocate processing of another service, which is different from the first service and the second service, to the worker thread after the operation of transferring the service call information to the interworking support unit.

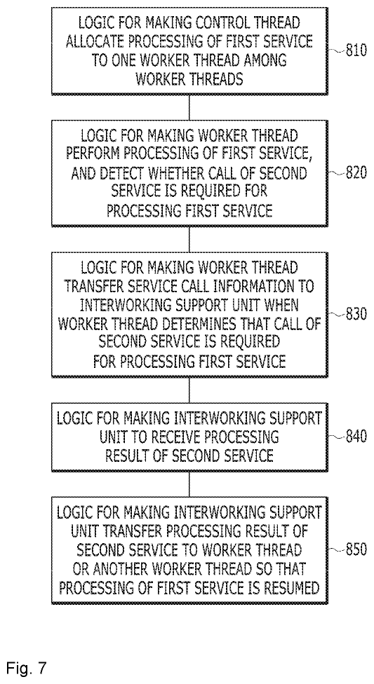

FIG. 7 is a block diagram illustrating logic for implementing the service processing method according to the exemplary embodiment of the present disclosure.

The service processing method according to the exemplary embodiment of the present disclosure may be implemented by the logic described below.

The service processing method according to the exemplary embodiment of the present disclosure may be implemented by: logic 810 for making the control thread allocate processing of a first service to one worker thread among the worker threads; logic 820 for making the worker thread perform the processing of the first service and making the worker thread determine whether a call of a second service is required for processing the first service; logic 830 for making the worker thread transfer service call information to the interworking support unit when the worker thread determines that the call of the second service is required for processing the first service; logic 840 for making the interworking support unit receive a processing result of the second service; and logic 850 for making the interworking support unit transfer the processing result of the second service to the worker thread or another worker thread so that the processing of the first service is resumed.

In an alternative exemplary embodiment of the service processing method, the service processing method may also include logic for making the worker thread store a processing state of the first service and making the worker thread stop the processing of the first service.

In the alternative exemplary embodiment of the service processing method, the service processing method may also further include logic for, when the worker thread determines that the call of the second service is required for processing the first service, making the control thread allocate processing of another service, which is different from the first service and the second service, to the worker thread after the operation of transferring the service call information to the interworking support unit.

Those skilled in the art shall recognize that the various illustrative logical blocks, configurations, modules, circuits, means, logic, and algorithm operations described in relation to the exemplary embodiments additionally disclosed herein may be implemented by electronic hardware, computer software, or in a combination of electronic hardware and computer software. In order to clearly exemplify interchangeability of hardware and software, the various illustrative component, blocks, configurations, means, logic, modules, circuits, and operations has been generally described above in the functional aspects thereof. Whether the functionality is implemented by hardware or software depends on a specific application or design restraints given to the general system. Those skilled in the art may implement the functionality described by various methods for each of the specific applications, but it shall not be construed that the determinations of the implementation deviate from the range of the contents of the present disclosure.

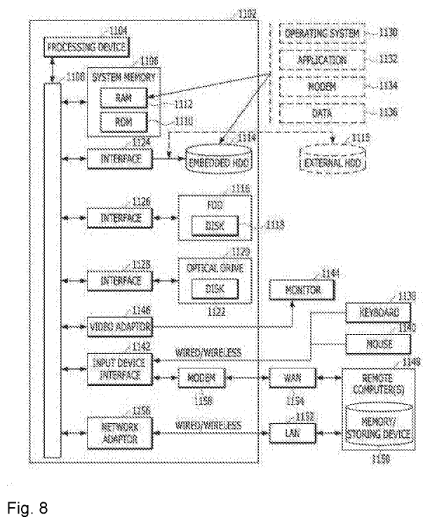

FIG. 8 is a simple and general schematic diagram of an illustrative computing environment, in which the exemplary embodiments of the present disclosure may be implemented.

The present disclosure has been generally described in relation to a computer executable command executable in one or more computers, but those skilled in the art will appreciate well that the present disclosure may be implemented in combination with other program modules and/or in a combination of hardware and software.

In general, a program module includes a routine, a program, a component, a data structure, and the like performing a specific task or implementing a specific abstract data type. Further, those skilled in the art will appreciate well that the method of the present disclosure may be carried out by a personal computer, a hand-held computing device, a microprocessor-based or programmable home appliance (each of which may be connected with one or more relevant devices and be operated), and other computer system configurations, as well as a single-processor or multiprocessor computer system, a mini computer, and a main frame computer.

The exemplary embodiments of the present disclosure may be carried out in a distribution computing environment, in which certain tasks are performed by remote processing devices connected through a communication network. In the distribution computing environment, a program module may be positioned in both a local memory storage device and a remote memory storage device.

The computer generally includes various computer readable media. A computer accessible medium may be a computer readable medium regardless of the kind of medium, and the computer readable medium includes volatile and non-volatile media, transitory and non-non-transitory media, portable and non-portable media. As a non-limited example, the computer readable medium may include a computer readable storage medium and a computer readable transport medium. The computer readable storage medium includes volatile and non-volatile media, transitory and non-non-transitory media, portable and non-portable media constructed by a predetermined method or technology, which stores information, such as a computer readable command, a data structure, a program module, or other data. The computer storage medium includes a read only memory (RAM), a read only memory (ROM), electrically erasable and programmable ROM (EEPROM), a flash memory, or other memory technologies, a compact disc (CD)-ROM, a digital video disk (DVD), or other optical disk storage devices, a magnetic cassette, a magnetic tape, a magnetic disk storage device, or other magnetic storage device, or other predetermined media, which are accessible by a computer and are used for storing desired information, but is not limited thereto.

The computer readable transport medium generally includes all of the information transport media, such as a carrier wave or other transport mechanisms, which implement a computer readable command, a data structure, a program module, or other data in a modulated data signal. The modulated data signal means a signal, of which one or more of the characteristics are set or changed so as to encode information within the signal. As a non-limited example, the computer readable transport medium includes a wired medium, such as a wired network or a direct-wired connection, and a wireless medium, such as sound, radio frequency (RF), infrared rays, and other wireless media. A combination of the predetermined media among the foregoing media is also included in a range of the computer readable transport medium.

An illustrative environment 1100 including a computer 1102 and implementing several aspects of the present disclosure is illustrated, and the computer 1102 includes a processing device 1104, a system memory 1106, and a system bus 1108. The system bus 1108 connects system components including the system memory 1106 (not limited thereto) to the processing device 1104. The processing device 1104 may be a predetermined processor among various common processors. A dual processor and other multi-processor architectures may also be used as the processing device 1104.

The system bus 1108 may be a predetermined one among several types of bus structure, which may be additionally connectable to a local bus using a predetermined one among a memory bus, a peripheral device bus, and various common bus architectures. The system memory 1106 includes a ROM 2110, and a RAM 2112. A basic input/output system (BIOS) is stored in a non-volatile memory 2110, such as a ROM, an erasable and programmable ROM (EPROM), and an EEPROM, and the BIOS includes a basic routine helping a transport of information among the constituent elements within the computer 1102 at a time, such as starting. The RAM 2112 may also include a high-rate RAM, such as a static RAM, for caching data.

The computer 1102 also includes an embedded hard disk drive (HDD) 2114 (for example, enhanced integrated drive electronics (EIDE) and serial advanced technology attachment (SATA))—the embedded HDD 2114 being configured for outer mounted usage within a proper chassis (not illustrated)—a magnetic floppy disk drive (FDD) 2116 (for example, which is for reading data from a portable diskette 2118 or recording data in the portable diskette 2118), and an optical disk drive 1120 (for example, which is for reading a CD-ROM disk 1122, or reading data from other high-capacity optical media, such as a DVD, or recording data in the high-capacity optical media). A hard disk drive 2114, a magnetic disk drive 2116, and an optical disk drive 1120 may be connected to a system bus 1108 by a hard disk drive interface 1124, a magnetic disk drive interface 1126, and an optical drive interface 1128, respectively. An interface 1124 for implementing an outer mounted drive includes at least one of or both a universal serial bus (USB) and the Institute of Electrical and Electronics Engineers (IEEE) 1394 interface technology.

The drives and the computer readable media associated with the drives provide non-volatile storage of data, data structures, computer executable commands, and the like. In the case of the computer 1102, the drive and the medium correspond to the storage of predetermined data in an appropriate digital form. In the description of the computer readable storage media, the HDD, the portable magnetic disk, and the portable optical media, such as a CD, or a DVD, are mentioned, but those skilled in the art will appreciate well that other types of compute readable storage media, such as a zip drive, a magnetic cassette, a flash memory card, and a cartridge, may also be used in the illustrative operation environment, and the predetermined medium may include computer executable commands for performing the methods of the present disclosure.

A plurality of program modules including an operation system 2130, one or more application programs 2132, other program modules 2134, and program data 2136 may be stored in the drive and the RAM 2112. An entirety or a part of the operation system, the application, the module, and/or data may also be cached in the RAM 2112. Those skilled in the art will appreciate well that the present disclosure may be implemented by several commercially available operating systems or a combination of the operating systems.

A user may input a command and information to the computer 1102 through one or more wired/wireless input devices, for example, a keyboard 2138 and a pointing device, such as a mouse 1140. Other input devices (not illustrated) may be a microphone, an IR remote controller, a joystick, a game pad, a stylus pen, a touch screen, and the like. The foregoing and other input devices are frequently connected to the processing device 1104 through an input device interface 1142 connected to the system bus 1108, but may be connected by other interfaces, such as a parallel port, an IEEE 1394 serial port, a game port, a USB port, an IR interface, and other interfaces.

A monitor 1144 or other types of display devices are also connected to the system bus 1108 through an interface, such as a video adapter 1146. In addition to the monitor 1144, the computer generally includes other peripheral output devices (not illustrated), such as a speaker and a printer.

The computer 1102 may be operated in a networked environment by using a logical connection to one or more remote computers, such as remote computer(s) 1148, through wired and/or wireless communication. The remote computer(s) 1148 may be a workstation, a computing device computer, a router, a personal computer, a portable computer, a microprocessor-based entertainment device, a peer device, and other general network nodes, and generally includes some or an entirety of the constituent elements described for the computer 1102, but only a memory storage device 1150 is illustrated for simplicity. The illustrated logical connection includes a wired/wireless connection to a local area network (LAN) 1152 and/or a larger network, for example, a wide area network (WAN) 1154. The LAN and WAN networking environments are general in an office and a company, and make an enterprise-wide computer network, such as an Intranet, easy, and all of the LAN and WAN networking environments may be connected to a worldwide computer network, for example, Internet.

When the computer 1102 is used in the LAN networking environment, the computer 1102 is connected to the local network 1152 through a wired and/or wireless communication network interface or an adapter 1156. The adapter 1156 may make wired or wireless communication to the LAN 1152 easy, and the LAN 1152 may also include a wireless access point installed therein for the communication with the wireless adapter 1156. When the computer 1102 is used in the WAN networking environment, the computer 1102 may include a modem 1158 connected to a communication computing device on a WAN 1154, or includes other means setting communication through the WAN 1154 via the Internet and the like. The modem 1158, which may be an embedded or outer-mounted and wired or wireless device, is connected to the system bus 1108 through a serial port interface 1142. In the networked environment, the program modules described for the computer 1102 or some of the program modules may be stored in a remote memory/storage device 1150. The illustrated network connection is illustrative, and those skilled in the art will appreciate well that other means setting a communication link between the computers may be used.

The computer 1102 performs an operation of communicating with a predetermined wireless device or entity, for example, a printer, a scanner, a desktop and/or portable computer, a portable data assistant (PDA), a communication satellite, predetermined equipment or place related to a wirelessly detectable tag, and a telephone, which is disposed by wireless communication and is operated. The operation includes a wireless fidelity (Wi-Fi) and Bluetooth wireless technology at least. Accordingly, the communication may have a pre-defined structure, such as a network in the related art, or may be simply ad hoc communication between at least two devices.

The Wi-Fi enables a connection to the Internet and the like even without a wire. The Wi-Fi is a wireless technology, such as a cellular phone, which enables the device, for example, the computer, to transmit and receive data indoors and outdoors, that is, in any place within a communication range of a base station. A Wi-Fi network uses a wireless technology, which is called IEEE 802.11 (a, b, g, etc.) for providing a safe, reliable, and high-rate wireless connection. The Wi-Fi may be used for connecting to the computer, the Internet, and the wired network (IEEE 802.3 or Ethernet is used). The Wi-Fi network may be operated at, for example, a data rate of 11 Mbps (802.11a) or 54 Mbps (802.11b) in an unauthorized 2.4 and 5 GHz wireless band, or may be operated in a product including both bands (dual bands).

Those skilled in the art may appreciate that information and signals may be expressed by using predetermined various different technologies and techniques. For example, data, indications, commands, information, signals, bits, symbols, and chips referable in the foregoing description may be expressed with voltages, currents, electromagnetic waves, electromagnetic fields or particles, optical fields or particles, or a predetermined combination thereof.

Those skilled in the art will appreciate that the various illustrative logical blocks, modules, processors, means, circuits, and algorithm operations described in relation to the exemplary embodiments disclosed herein may be implemented by electronic hardware (for convenience, called “software” herein), various forms of program or design code, or a combination thereof. In order to clearly describe compatibility of the hardware and the software, various illustrative components, blocks, modules, circuits, and operations are generally illustrated above in relation to the functions of the hardware and the software. Whether the function is implemented as hardware or software depends on design limits given to a specific application or an entire system. Those skilled in the art may perform the function described by various schemes for each specific application, but it shall not be construed that the determinations of the performance depart from the scope of the present disclosure.

Various exemplary embodiments presented herein may be implemented by a method, a device, or a manufactured article using a standard programming and/or engineering technology. A term “manufactured article” includes a computer program, a carrier, or a medium accessible from a predetermined computer-readable device. For example, the computer-readable storage medium includes a magnetic storage device (for example, a hard disk, a floppy disk, and a magnetic strip), an optical disk (for example, a CD and a DVD), a smart card, and a flash memory device (for example, an EEPROM, a card, a stick, and a key drive), but is not limited thereto. Further, various storage media presented herein includes one or more devices and/or other machine-readable media for storing information.

It shall be understood that a specific order or a hierarchical structure of the operations included in the presented processes is an example of illustrative accesses. It shall be understood that a specific order or a hierarchical structure of the operations included in the processes may be re-arranged within the scope of the present disclosure based on design priorities. The accompanying method claims provide various operations of elements in a sample order, but it does not mean that the claims are limited to the presented specific order or hierarchical structure.

The description of the presented exemplary embodiments is provided so as for those skilled in the art to use or carry out the present disclosure. Various modifications of the exemplary embodiments may be apparent to those skilled in the art, and general principles defined herein may be applied to other exemplary embodiments without departing from the scope of the present disclosure. Accordingly, the present disclosure is not limited to the exemplary embodiments suggested herein, and shall be interpreted within the broadest meaning range consistent to the principles and new characteristics suggested herein.

What is claimed is:

1. A computer program stored in a computer readable storage medium, the computer program making operations for processing a service be performed when the computer program is executed in one or more processors of a computing device,
the operations including:
an operation of allocating, by a control thread, processing of a first service to one worker thread among worker threads;
an operation of performing, by the worker thread, the processing of the first service and determining whether a call of a second service is required for processing the first service;
an operation of transferring, by the worker thread, service call information to an interworking support unit when the worker thread determines that the call of the second service is required for processing the first service;
an operation of receiving, by the interworking support unit, a processing result of the second service; and
an operation of transferring, by the interworking support unit, the processing result of the second service to the worker thread or another worker thread so that the processing of the first service is resumed.

2. The computer program of claim 1, wherein the operation of transferring, by the worker thread, the service call information to the interworking support unit when the worker thread determines that the call of the second service is required for processing the first service includes an operation of storing, by the worker thread, a processing state of the first service and stopping the processing of the first service.

3. The computer program of claim 1, wherein the service call information includes at least one of identification information about a service calling a service, identification information about a service desired to be called, and transaction identification information.

4. The computer program of claim 1, further comprising:
after the operation of transferring, by the worker thread, the service call information to the interworking support unit when the worker thread determines that the call of the second service is required for processing the first service, an operation of allocating, by the control thread, processing of another service, which is different from the first service and the second service, to the worker thread.

5. The computer program of claim 1, wherein the second service is the service different from the first service, and is the service, which needs to be processed first, for completion of the processing of the first service.

6. The computer program of claim 1, further comprising:
an operation of interworking, by the interworking support unit, the received processing result of the second service with the first service based on the service call information.

7. The computer program of claim 6, wherein the processing result of the second service includes at least one of processing result information about the second service, identification information about the first service, and transaction identification information.

8. A method of processing a service performed by one or more processors of a computing device, the method comprising:
allocating, by a control thread, processing of a first service to one worker thread among worker threads;
performing, by the worker thread, the processing of the first service and determining whether a call of a second service is required for processing the first service;
transferring, by the worker thread, service call information to an interworking support unit when the worker thread determines that the call of the second service is required for processing the first service;
receiving, by the interworking support unit, a processing result of the second service; and
transferring, by the interworking support unit, the processing result of the second service to the worker thread or another worker thread so that the processing of the first service is resumed.

9. A computing device for processing a service, the computing device comprising:
a processor including one or more cores; and
a memory configured to store commands performable by the processor,
wherein in the processor,
a control thread allocates processing of a first service to one worker thread among worker threads;
the worker thread performs the processing of the first service and determines whether a call of a second service is required for processing the first service;
the worker thread transfers service call information to an interworking support unit when the worker thread determines that the call of the second service is required for processing the first service;
the interworking support unit receives a processing result of the second service; and
the interworking support unit transfers the processing result of the second service to the worker thread or another worker thread so that the processing of the first service is resumed.
